(19) United States
(12) Patent Application Publication
(10) Pub. No.: US 2015/0300479 A1
(43) Pub. Date: Oct. 22, 2015

(54) WORM GEAR MECHANISM

(71) Applicant: IMO HOLDING GMBH, Gremsdorf (DE)

(72) Inventor: Hubertus Frank, Höchstadt (DE)

(21) Appl. No.: 14/646,631

(22) PCT Filed: Nov. 21, 2012
(86) PCT No.: PCT/EP2012/004820

§ 371 Date: May 21, 2015

(51) Int. Cl. F16H 57/01; G01D 5/14; F16H 57/021; F16H 1/16; F16H 57/039

(52) U.S. Cl. CPC F16H 57/01; F16H 1/16; F16H 57/039; F16H 57/021; G01D 5/142; F16H 2057/012; F16H 2057/0213

(57) ABSTRACT

The invention is directed to a worm gear mechanism comprising a worm shaft with a worm thread formed or worked, in particular cut, directly into the shaft main body, and also comprising a worm wheel that meshes with said worm thread, which worm wheel is of annular form and is integrated with an annular connection element of an open-center large-diameter rolling bearing, the two annular, mutually concentric connection elements of which are supported against one another in rotatable fashion and serve for connection to two machine or installation parts that are rotatable relative to one another, wherein the toothed worm wheel connection element is formed from an annular main body with a toothing formed or worked directly therein, having at least one connection surface for abutment against a planar contact surface of the respective machine or installation part, and having multiple fastening bores arranged so as to be distributed in a ring around the clear opening, the longitudinal axes of which bores extend perpendicularly through the respective connection surface; and wherein the non-toothed connection element is formed from an annular main body with at least one planar connection surface for abutment against a planar contact surface of the respective machine or installation part, and having multiple fastening bores arranged distributed in a ring around the clear opening, the longitudinal axes of which bores extend perpendicularly through the respective connection surface; wherein furthermore, in the region of the worm, sensors are provided which permanently detect the (rotational) position of the worm; and to a method for the operation of a worm gear mechanism of said type.

The invention relates, on the one hand, to a worm gear mechanism, comprising a worm shaft with a worm thread formed or worked, in particular cut, directly into the shaft main body, and also comprising a worm wheel that meshes with said worm thread, which worm wheel is of annular form and is integrated with one of two annular, mutually concentric connection elements, which are supported against each other in rotatable fashion and serve for connection to two machine or installation parts that are rotatable relative to each other; and to a method for the operation of a worm gear mechanism of said type. Preferably, the diameter of the smallest, clear opening within both the connection elements is equal to or larger than half the diameter of the bearing between both the connection elements, in particular equal to or larger than half the reference circle diameter of the radially outermost rolling element row of the connection elements that are rotatable relative to each other.

Worm gears bring about a change in the direction of rotation and at the same time a reduction in speed between a driving and a driven machine part; the associated torque transmission allows one to rotate or slew heavy plants with low-power driving means. Moreover, there are self-locking worm gears, which can be simultaneously used as a stopping brake. Because of these advantageous characteristics, such worm gear mechanisms are often used for heavy duty drives, where large forces and torques are generated, for example in construction machinery and vehicles, cranes, demolition equipment, wind energy plants, etc. Such vehicles, equipment and systems, however, present a risk of heavy wear, because completely controllable natural forces such as large weight forces, tilt forces, wind forces, etc., often are not completely controllable in such applications.

This can result in operating conditions that have a significant influence on the wear and tear of the respective worm gear mechanism. In addition, the absolute rolling angle can often fluctuate over a wide range, likewise leading to premature ageing of specific elements of the worm gear mechanism.

The wear that occurs in this way is particularly important in respect of the rolling element raceway system as well as in respect of the toothing. Whereas for the first, the absolute rolling angle covered is primarily relevant, the toothing, on the other hand, suffers primarily under a frequent or permanent exposure of the worm gear to torque load.

In state of the art technology, the most diverse load cases encountered in practice are taken into account primarily by selecting sufficiently short maintenance intervals so that the bulk of the worm gear can be sufficiently monitored. However, this measure is not completely satisfactory. This is because, on the one hand, maintenance with inspection requires the disassembly and the dismantling of a worm gear mechanism, including its bearing, so that the condition of the toothing, in particular also of the otherwise inaccessible raceways, can be detected. This entails a high level of expenditure in some applications; for example, in wind energy plants, where a dismantling of the rotor bearing and blade bearings at aerial height is possible only with a high expenditure in terms of personnel and time, in particular also because wind energy plants are often constructed at places that are difficult to access, such as in offshore areas or the like. Even when a slew drive of an excavator or the like is dismantled, the said excavator is put out of service for one or (usually) more days.

On the other hand, it can happen, even in spite of short maintenance intervals, that repair is required even before the next scheduled maintenance round due to increased wear caused by overexposure to stress. In such cases, the problem is usually detected too late, and typically only when the device breaks down prematurely. Equally disadvantageous is the fact that any such (shorter) maintenance intervals are always associated with an increased number of checks that must be performed by five human persons, who inspect the plant or device or check its functional fitness. Even if, in the desired scenario, no damage or wear or defect in a plant or device can be detected during such an inspection or check, maintenance costs are nonetheless incurred, at least in the form of time costs of maintenance staff.

The disadvantages of the described state of art give rise to the problem that triggered the invention, namely the problem of further developing a generic worm gear in such a way that the degree of wear of the worm gear can be detected with a low level of expenditure and, primarily, with a higher level of informative accuracy. This problem is resolved in that special sensor technology components in accordance with the present invention are used for permanent monitoring of the worm gear, which makes the periodical maintenance of plants or devices of worm gear type obsolete to a large extent.

At the same time, the toothed worm wheel connection element of the worm gear mechanism in accordance with the invention is formed from an annular main body, having a toothing formed or worked directly therein, and preferably with at least one raceway formed or worked directly into the main body, along which raceway rolling elements run directly, as well as having at least one planar connection surface formed or worked directly into the main body for abutment against a planar contact surface of the respective machine or installation part, having multiple, fastening bores arranged so as to be distributed in a ring around the clear opening; the longitudinal axes of these bores extend perpendicularly through the respective connection surface. Furthermore, the non-toothed connection element is formed from an annular main body and preferably with at least one raceway formed or worked directly therein along which rolling elements run directly, as well as having at least one planar connection surface formed or worked directly into the main body of the non-toothed connection element, for abutment against a planar contact surface of the respective machine or installation part. Furthermore, the worm gear mechanism in accordance with the invention has multiple fastening bores directly formed or worked into the main body of the non-toothed connection element and arranged so as to be distributed in a ring around the clear opening; the longitudinal axes of these bores extend perpendicularly through the respective connection surface; wherein furthermore, in the region of the worm, at least one sensor is provided which permanently detects the rotational and/or displacement position of the worm, and preferably an evaluation unit for forming the absolute value of the measured rotational or displacement path and also to integrate it as necessary.

Such a worm gear mechanism is an assembly group often referred to by experts as a slew drive, which is nowadays mostly completely encapsulated, i.e. enclosed in a housing, in order to shield sensitive components as far as possible from environmental influences such as corrosive ocean air, contaminants, etc. Hereinafter, primarily the rolling elements, their raceways as well as the toothing of the annular worm wheel connection element and the toothing of the worm shall be considered as sensitive components.

Normally, only two mutually concentric, annular connection elements are accessible from outside and have mutually parallel connection surfaces that face away from each other, each of which connection surfaces serves for connection with one of two installation or machine parts that are rotatable relative to each other; also accessible from outside is one connection each for the rotor and the stator of a drive motor for rotary adjustment of both the annular connection elements relative to each other, as well as one further connection for a brake, a tachometer or the like as necessary.

Such a slew drive combines multiple advantageous characteristics as regards application: An integrated bearing ensures a parallel orientation of both the connection surfaces and thereby the precise parallel movement of a fitted installation element relative to a foundation, chassis or the like, so that further guidance—or bearing elements can be dispensed with.

By means of a connectible motor, the relative angle of rotation or even the relative speed between both the connected installation parts can be precisely adjusted. The motor is usually coupled to the worm of a worm gear for rotation therewith, wherein the annular gear rim that meshes with the worm is not disposed on a worm wheel, but is arranged circumferentially around a worm ring, namely on one of the two annular connection elements, so that the motor can have a rotary adjustment effect on said worm ring.

Such an arrangement not only ensures torque transmission, but also torque multiplication while simultaneously reducing the speed. This in turn has multiple decisive advantages:

On the one hand, a conventional motor with a comparably high nominal speed and a relatively low nominal torque can be used, as the gear reduction causes both the values to be transformed 30 into value ranges that are advantageous for heavy duty drive.

On the other hand, such a worm gear mechanism can easily be designed so as to be self-locking, i.e. large, even very large, load torques passing through the two annular connection elements cannot twist them away from each other, because the meshing action of the toothing with the worm blocks this. That is why a brake, in particular a stopping brake, besides a control when the motor is stationary, can be dispensed with in many cases so that design-related expenditure and energy can be saved. On the other hand, this also presents risks:

This is because, if theoretically infinitely large torques passing through the connection elements are blocked, then even the most sturdily built slew drive can be damaged or destroyed, i.e. in particular the intermeshed toothing and thread flanks can be damaged.

In similar manner, the bearing can be damaged or destroyed due to excessively large overturning torques or axial forces, in particular the rolling elements and/or raceways.

Due to these correlations, the achievable service life of a slew drive is very decisively dependent on the type of load it is exposed to. If the said slew drive is constantly exposed to moderate torques and overturning torques as well as axial forces, so that it achieves its fatigue strength, it can theoretically keep going infinitely; the service life is, however, influenced by secondary parameters such as corrosion, wear, etc. However, if the slew drive is frequently exposed to loads in the range of its nominal data or even beyond that, then the service life is limited and is reduced in the measure of its exposure or over-exposure to loads. That is why the maintenance intervals must actually be specified depending upon the respective load case, which cannot, however, be implemented in practice, since a special load case normally cannot be evaluated neutrally in the absence of measured data.

As a substitute measure for this, it is envisaged that the specific application case will be measured in accordance with the invention, in order to derive from that measurement the benchmark data for determining the optimum maintenance interval. This purpose is served by a sensor for determining the forces acting on the worm. This is because it is primarily the torques between the annular connection elements that are transformed into axial forces acting on the worm, so that axial displacements or forces on the worm are excellently suited as a criterion of the torque load on the slew drive.

Axial displacements of the worm occur primarily if the worm is spring-mounted in an axial direction for cushioning against torque impulses. Based on Hooke's law, the displacement of the worm in the process is proportional to the axial displacement force, therefore proportional to the torque that is passing through the two annular connection elements, and must be generated or compensated by the worm, and can therefore serve as a measure of the load on the intermeshed toothing or thread flanks.

On the other hand, the number of worm revolutions is directly proportional to the relative number of revolutions of both the connection elements, and therefore represents a measure of the wear of the rolling elements and raceways.

Through integration with the parameters measurable at the worm, i.e. with the so-called measured values, it is possible to draw conclusions regarding the mean load of the slew drive, in particular in the region of the toothing and thread flanks on the one hand, and concerning the rolling elements and raceways on the other hand

These integrated parameters or measured values can, e.g., be classified in tabular form in a diagram of load ranges according to time- or operating time intervals, so that error-free conclusions can be drawn regarding the expected wear of the bearing, based on which maintenance intervals can ultimately be determined or current maintenance requirements can ultimately be formulated. In the fundamental, technical terminology of measurement technology, such a pre-calculation of maintenance intervals based on measured or sensed values is referred to as “proactive maintenance” or “condition monitoring” or “condition detection”. Ever since so-called on-board computers came into existence in automotive technology, fixed maintenance intervals for brake pads or air filters, e.g., do not have to be “specified”, but can be determined according to the requirement and situation in each individual case through intelligent use of sensor technology. This kind of monitoring according to the individual situation is referred to as “Condition Monitoring” or “Condition Based Monitoring”.

The worm gear mechanism in accordance with the present invention is therefore provided with mechanisms for proactive maintenance or with devices for condition monitoring or condition detection.

A sensor that measures the forces and/or movements of the worm relative to its housing should be fixed to the housing, and namely in such a way that its sensitive region is facing towards the worm shaft so that it can scan it and/or detect its position and/or movement.

If the sensor functions with contactless technology, in particular magnetic or optical scanning of at least one of the reference elements fixed to the worm gear, then it has no influence on the service life of the slew drive, but remains purely an uninvolved observer of the actual events. The measurement itself, therefore, has no direct or indirect modifying or falsifying effect on the service life of the slew drive.

An inductive scanning or sensing also serves to determine the parameters or measured values with the help of contactless technology.

In the context of an embodiment of the invention, an (angle) sensor can be provided to sense the direction of rotation of the worm, from which conclusions can be drawn regarding the path over which the rolling elements have rolled.

The sensor can, e.g., be designed as a magnetic sensor, in particular as a hall effect sensor, which preferably interacts with a reference element in order to detect its relative movement. A magnetic sensor can, for instance, react to a magnet disposed in or on the worm shaft. To avoid imbalances, even two magnets diametrically opposed to each other could be arranged on the worm shaft.

To react, e.g., to protrusions or depressions of the worm shaft, inductive (proximity-) switches are provided, which measure the changes in inductance of a coil with the help of a movable (metallic-) element in direct proximity.

To detect the direction of rotation and/or for determining the absolute angle, two or three sensors could be used of the type that can be arranged with an offset relative to each other in circumferential direction and/or in axial direction, so as to be able to react to the same magnetic elements, protrusions or depressions, or to different ones that are arranged with an offset relative to each other. In the case of three sensors, displaced at an angle of 120° from each other in circumferential direction, the direction of rotation can even be concluded from the sequence of their response.

If the reference element or magnet extends across half the circumference of the worm shaft, then one period of its measurement signal covers one impulse as well as one approximately equally wide gap—at constant speed of the worm shaft. If two such sensor arrangements with identical geometry of the reference element or magnet are displaced relative to each other by about one-quarter of the circumference, then four distinct phases per period are present—depending upon whether one or the other measurement signal shows an impulse or both of them or none of them—and the current direction of rotation can be explicitly detected from the sequence of these phases.

For such an arrangement, it is not necessary to use two different reference elements or magnets; instead, it is sufficient if two similar sensors are displaced at a central angle of 90° relative to each other, so that the sensor signals are phase shifted. Even one such reference element alone extending across approximately half the circumference can, in many application cases, deliver results that are sufficiently accurate for the invention in general, since each complete rotation of the worm shaft is detected therewith. A single-start worm rotates once completely around its axis, while the toothed connection ring moves exactly one tooth forward.

In such a single-start worm, the transmission ratio is thus ü=n_{A}/nₛ=1/z, where nA is the speed of the toothed connection element, ns stands for the speed of the worm, and z is the number of teeth of the toothed connection element. The speed nₛ of the worm is thus equal to the speed of the toothed connection element, multiplied by its number of teeth:

nₛ=n_{A}*z.

That is why it is generally sufficient to count the number of rotations of the worm shaft for each specific direction of rotation, i.e., positive for forward direction, negative for backward direction, in order to detect which tooth is currently meshed with the worm, i.e. which tooth currently provides the torque transmission of the worm shaft. The tooth flank involved, i.e. the front one or back one in the direction of rotation—is derived less from a more accurate analysis of the angle of rotation, and more or predominantly from the direction of the transmitted torque, since each tooth flank can only transmit pressure forces.

Although magnets exert forces, the resulting effects are cancelled in the course of a continuous rotation—a magnet attracts in the direction of rotation when approaching a ferromagnetic material, and attracts in the direction of deceleration when subsequently passing and moving away from the same ferromagnetic material. Furthermore, these forces are negligibly small in comparison with the forces that are otherwise generated in the slew drive.

Less for reasons of accuracy, and more for the purpose of avoiding imbalances, two or three or four or even more such reference elements can be used instead of one single magnetic or metallic reference element—in general k reference elements, where each reference element extends across an angle of approx. 180° /k, with k =2, i.e. e.g. across 90°, and where adjacent reference elements are arranged in a way that they are displaced at just the same angle of approximately 180° /k relative to each other. For all k >2, such an arrangement is balanced by approximation; at the same time, the reading accuracy is multiplied to the k^{th} value, which is primarily important in frequently oscillating rotational movements, so that the overall degree of rolling can be determined as accurately as possible. This is because if the worm shaft oscillates by an angle of less than 90° in a sensor arrangement with k =1, and in the process does not exceed any phase limit monitored by the sensor, then the sensor does not detect such small movements at all, i.e. it does not count them at all. At k =2, the monitored phase limits of the sensor arrangement lie at intervals of 45°, at k =3 at intervals of 30°, generally at 90° /k.

Furthermore, in multiple start worms with number of starts g≧2, the toothed connection element moves forward by g teeth per rotation of the worm, so that in this case too, a more accurate calculation of the angle of rotation is advantageous for the purpose of determining as to which one out of the g teeth of the worm ring toothing has been exposed to which load during one rotation of the worm. For this reason, the invention recommends that the number k of the reference elements be selected to be at least equal to the number of starts g of the worm, or greater than that:

k≧g.

A reference mark on the worm shaft does not appear to be necessary for lower values of k, as that hardly delivers any additional information in that case. However, it would be conceivable to combine a magnetic sensor of the kind described above with another kind of sensor to improve its long-time accuracy. The other sensor could be, e.g., a similar sensor on the main housing of the worm gear, which scans a reference mark on the toothed connection element and therewith delivers a zero signal based on the angle of rotation of the toothed connection element, or a sensor described in the following, with a higher number k of reference markings on the circumference of the worm shaft.

Another possibility would be to design the sensor as an optical sensor, in particular by means of an element sensitive to light or infra-red radiation such as a photodiode. The photons that a light beam contains have no rest mass and therefore cannot generate any macroscopically perceivable forces. The intensity of the light beam is preferably high enough to determine explicitly identifiable measured values in spite of the lubricant or grease present in the worm gear.

An optical sensor can interact with a reference element in order to detect its relative movement, which reference element preferably covers one element fixed on the worm or the worm shaft with at least one outstanding coefficient of reflection. Preferably, a light or laser beam is generated in or near the sensor and is directed at an area of the worm shaft where a reference element with at least one pronounced coefficient of reflection is located or not, depending upon the direction of rotation of the worm shaft. The light that might be reflected there falls on a light-sensitive element, for example a photodiode, and produces a measurable photocurrent there, whereas when the reference element rotates further, reflected light does not fall on the light-sensitive element.

If the reference element in such an arrangement in circumferential direction covers multiple incremental markings spaced apart from each other and with a pronounced coefficient of reflection, then one single switch signal alone is not generated during one rotation, but a number commensurate with the number of incremental markings, for example 500 or 1,000. With that, even a minimal amount of rotation can be recorded reliably and precisely. If the width of a marking corresponds approximately to the width of the spacing between two adjacent markings, then one period of the measurement signal covers one impulse as well as an approximately equally wide gap. If two similar sensor arrangements with the same incremental division are displaced relative to each other by approximately half the width of a marking, then there are four distinct phases per period—depending upon whether one or the other measurement signal shows an impulse or both of them or none of them—and the current direction of rotation can be explicitly detected from the sequence of these phases.

As far as possible, the analytical device should be able to determine the direction of rotation of the worm or of the worm shaft. In magnetic sensors or in optical sensors with only a few incremental markings, such a detection of rotational direction can significantly increase the accuracy of the subsequent calculations.

The analytical device should determine and integrate the absolute (rotational) angle covered depending upon the direction of rotation of the worm or of the worm shaft. Only this delivers precisely the rolling distance covered by the rolling elements and thus permits an accurate prediction of the expected wear of the rolling elements and raceways.

As already indicated above, the worm or worm shaft can be supported such that it can be displaced axially so as to protect the worm thread and/or toothing on the worm wheel against torque impulses.

An axially displaceable worm or worm shaft can furthermore be spring-mounted in the axial direction, for example by means of at least one pressure spring, preferably by means of at least one disc spring, in particular by means of at least one laminated disc spring. Such a suspension converts a torque into a proportional, measurable deflection of the worm shaft in its longitudinal direction.

This makes it possible to capture this deflection by means of a (path) sensor and prepare it in such a way that the evaluation unit is in a position to determine the measure of the axial deflection of the worm or of the worm shaft. From that, it is possible to determine the torque currently applied by the worm on the toothed connection element in order to determine the load on the intermeshed elements.

In a worm shaft that is spring-mounted in both longitudinal directions, there is the further possibility of the evaluation unit determining and integrating the absolute (displacement) distance covered depending upon the direction of axial displacement of the worm or of the worm shaft, as a measure of the load on the intermeshed elements and of the resultant expected wear.

The value to be integrated can be weighted in a way that a torque or torque-like overload is weighted with a higher (proportionality) factor. The value to be integrated could even be distinguished with the help of a prefix depending upon a deflection of the worm shaft from an approximately central zero position in both axial directions, so that the forces acting on different flanks of the teeth could be evaluated independently of each other.

If the torque information is combined with the rotation angle information, the load on individual teeth of the worm wheel toothing can additionally be determined and evaluated so that the load on individual teeth can be detected and reported. This could be important, e.g., in blade bearings for pitch-controlled rotor blades of wind energy plants, in which the connection element at the blade end never executes one complete 360° rotation, but is always only displaced within an angle range of maximum 90°. If the adjusted angle value lies mostly at a specific angle of 45°, for instance, then the teeth meshing with the worm shaft at this angle are worn far more than the remaining teeth, and individual teeth can be worn out quickly in spite of a small rolling angle since the wind pressure acting on a rotor blade can give rise to high torques at the respective blade bearings. Being able to detect this is a significant advantage of this arrangement in accordance with the invention. To enable this, the total number of incremental markings k of all existing (angle) sensors should be equal to or greater than the z number of the teeth on the circumference of the toothed connection element multiplied by the reduction gear ratio ü=n_{A}/n_{S}, multiplied by the g number of starts of the worm. Then, one or more incremental markings can be assigned to each tooth. Since ü=n_{A}/n_{S}=1/z, it follows that:

k>g.

Furthermore, a sensor interacting with one single reference mark on the circumference of the worm shaft can be present, so that the arrangements with spacings can be calibrated or the effects of “overlooked” markings can be corrected and the resultant errors can be minimized For instance, a slew drive used as a blade bearing of a wind energy plant could intermediately locate the zero position in calm weather with the help of the reference mark and then start counting the incremental markings again from the beginning.

A memory for the integrated values of the evaluation unit provides information about the respective slew drive as required. To prevent memory overflow, intermediate evaluations can be carried out after specific intervals, in which evaluations the cumulative distance and/or angle values are divided by the respective time interval in order to arrive at time-weighted mean values. If the respective time values are stored in addition to these mean values—unless they are in any case constant—then the relevant weight of multiple mean values saved in this way can be taken into account when carrying out a later overall evaluation.

It is possible to save the type, duration, extent and/or number of speed-related or torque-related overloads, in particular their respective maximum values. With that, it is possible to predict the potential damage to the slew drive so that serious function impairments can be detected—as separate from the expected wear.

An interface permits the reading of the saved information. This can be, for instance, a wired interface, a wireless interface or a data transmission option via infra-red signal.

For uninterrupted operation of the sensor and of the evaluation unit, the arrangement in accordance with the invention should have at least one rechargeable battery which constantly supplies the components according to the invention with auxiliary energy.

Such a battery can be rechargeable via a power supply connection or via a photodiode or via an induction coil, in particular in the context of a transponder.

A housing that completely encompasses the worm and the toothed worm wheel-connection element except for its connection surfaces and thereby protects these areas against external influences, is preferably connected to or integrated with the untoothed connection element.

Another design specification states that the housing, with the exception of an attachment for the worm, demonstrates a rotationally symmetrical form that is concentric relative to the rotation axis of the toothed worm wheel connection element. With that, the intermeshing elements can be fully encompassed with minimal utilisation of space.

It has proved to be advantageous that at least one raceway each is directly formed or worked in the main body of one or both of the connection elements, along which raceways rolling elements run directly.

Directly forming or working the raceways in the respective main bodies has the advantage that, on the one hand, the rolling elements never encounter or have to overcome any joint in the course of their rolling movement, which significantly enhances the operating time. On the other hand, the raceways are directly coupled to the stiffness of the connection elements—which are possibly coupled to the stiffness of a connected machine or installation part.

With these advantages, the ideal preconditions for a long lifetime of the rolling elements and raceways are created. After all, a number of disruptive parameters are eliminated in this way, so that the relation between measured load on the one hand and expected wear on the other hand can be predicted quite accurately, as a result of which maintenance intervals or maintenance requirements can be determined or generated with a high level of accuracy.

It is within the scope of the invention that at least one raceway and/or the toothing of the toothed connection element and/or the thread of the worm is hardened, preferably surface hardened, in particular induction hardened. This measure also improves the expected service life, on the one hand, and protects the sensitive elements of the slew drive against unforeseeable damage at the same time, so that the calculated rate of wear of these parts is not influenced by unforeseeable events.

The rolling bearing should demonstrate 20 or more rolling elements, preferably 35 or more, in particular 50 or more. If there are a large number of rolling elements, the overturning torques, for instance,as well as axial forces, always get distributed over multiple rolling elements—the individual rolling element is relieved of load and is thereby only subjected to general wear, which can be determined by the number of rolling actions.

For a similar reason, the toothing of the toothed worm wheel connection element should demonstrate 20 or more teeth, preferably 35 or more, in particular 50 or more.

In this way, the meshing range can be distributed over multiple tooth and thread flank pairs, in particular if the worm demonstrates a so-called globoid toothing on one side or both sides of the meshing point, also referred to as “hourglass”. The main body of the worm then fuses optimally with the worm ring.

Furthermore, it is recommended in accordance with the invention that 8 or more, preferably 12 or more, in particular 20 or more fastening bores be provided per connection element. With a correspondingly large number of screw connections, the respective connection element is virtually fused with the connecting structure, i.e., both parts buttress each other.

With that, the risk of distortion of an annular connection element is reduced as far as possible, and the rolling elements encounter optimal operating conditions, so that the risk of unforeseeable impairments or even damage is minimized

In an arrangement of the fastening bores of the toothed connection element in radial respect between the circumferential toothing on the one hand and a raceway of at least one row of rolling elements on the other hand, all the forces and torques introduced through this means of construction can be exchanged within a common plane. In this way, the individual forces and torques can be largely uncoupled and are then better calculable with the help of the parameters or measured values that can be read off the worm.

Further advantages can be achieved by having at least one raceway for supporting the worm shaft directly formed or worked in the main body of the shaft.

This results in an arrangement that is reduced to the essential elements: A connection element is connected or even fused to, i.e. integrated with, the housing of the slew drive for rotation therewith; the other connection element is rotatably supported by the first connection element via a series of rolling elements and is preferably equipped with a circumferential row of teeth; the shaft body is supported by the housing via at least one row of rolling elements preferably two of them—and meshes with the row of teeth of the second connection element via its thread. By dispensing with separate bearing components, for example bearing rings, raceway segments or the like, the possibility of deformations within the bearing is minimized, and the conditions become manageable and calculable. A further development of the invention, described in the following, particularly also contributes to this, according to which development at least one raceway serving as a bearing for the worm shaft as well as the worm thread is formed in one single, common main body of the shaft, in particular by being worked and/or preferably cut into it.

In order to distribute the meshing between the worm thread and the row of teeth meshing with it, over the maximum possible number of tooth and thread flank pairs, the worm thread must demonstrate four or more, preferably six or more, in particular eight or more rounds.

Another measure for improving the meshing conditions is to mutually adjust the course of thread meshing on the worm shaft and/or the cross-section of the teeth, in particular in the area of their free front side. This can be done by means of so-called globoid toothing or thread. In the process, the envelope of the worm shaft circumference assumes a form that is concave in the longitudinal direction of the shaft, wherein the (negative) crown radius of the worm shaft circumference approximately corresponds (in absolute terms) to the (positive) radius of the curved surface area bearing the preferably circumferential row of teeth on the toothed connection element. On the other hand, the (negative) crown radius of a curvature that is concave in the longitudinal direction of the axis of rotation and located in the outer circumference of the toothed connection element can approximately correspond to the (positive minimum) radius of the envelope of the worm thread at the meshing point. Through this measure, the thread and tooth flanks are relieved of load and the wear is reduced and becomes easier to calculate.

The method according to the invention, for the operation of a worm gear mechanism comprising a worm shaft with a worm thread formed or worked, in particular cut, directly into the shaft main body, and also comprising a worm wheel that meshes with said worm thread, which worm wheel is of annular form and is integrated with an annular connection element of an open-centre large-diameter rolling bearing, the two annular, mutually concentric connection elements of which are supported against one another in rotatable fashion via one or more rows of rolling elements and serve for connection to two machine or installation parts that are rotatable relative to one another, wherein the diameter of the smallest, clear opening within both the connection elements is equal to or larger than half the diameter of the bearing between both the connection elements, in particular equal to or larger than half the reference circle diameter of the radially outermost rolling element row of the connection elements that are rotatable relative to each other, is characterized by the following process steps:
a) the rotation and/or axial displacement of the worm or worm shaft is measured;
b) optionally, the measured value for the rotation and/or axial displacement of the worm or worm shaft can be rectified, unless this has already been done by the functioning of the sensor, and/or the subsequent evaluation can be assigned to different evaluation paths depending upon the angle of rotation and/or the direction of displacement and/or rotation, so that multiple parameters can be maintained;
c) the possibly rectified measured value(s) for the rotation and/or axial displacement is (are) integrated, and/or maximum values of the measured value(s) are determined;
d) the integral value(s) of the possibly rectified measured value(s) for the rotation and/or axial displacement is (are) saved, and/or maximum values of the measured value(s) are saved.

The special feature of this method is, among other things, that the slew drive itself—i.e. preferably without attaching a separate part—has its own intelligence and is therefore in a position to monitor itself, in particular for collecting data concerning operating mode for the purpose of evaluation of the intermediate wear that has occurred. These data are preferably evaluated for the purpose of reducing the storage expenditure, in order to specify the parameters typical for certain operating modes, after which the information obtained in this way is saved for the purpose of later reading by the operating and/or maintenance staff.

It has been demonstrated that important operating parameters can be read off the worm shaft particularly well. This is because, on the one hand, the worm shaft is relieved of a number of loads of the main bearing, for example it is relieved of its overturning torques and axial forces and, on the other hand, it is coupled to the toothed connection element for rotation therewith in respect of the main movement of the slew drive, i.e. in respect of its rotatory movement around its main axis, and can therefore communicate its rotatory movement to a sensor or the like without any changes.

Additionally disposed on the worm shaft is the drive motor, which is supplied with power, either via electric cable or via hydraulic lines, and therefore it is not at all difficult to lay one or more sensor lines as well in parallel to these lines. After all, the part of the housing accommodating the worm is highly exposed as compared to the remaining housing part and is therefore easy to access for maintenance and/or repair purposes, so that a defective sensor can be exchanged if necessary without having to dismantle the housing of the slew drive, which would not be possible without previously dismantling at least one of the attached machine or installation parts. Rather, a sensor can either be directly unscrewed from the housing, or, in the worst case, it would even be accessible from inside after dismantling a front-side cover of the worm housing of the slew drive, for instance, to check or adjust its correct interaction with a reference element or object on the worm shaft. To this end, it has proved to be useful to arrange the sensor(s) and/or reference elements or object(s) in the area of the front side of the worm housing facing away from the drive motor (i.e. the B-side cover of the worm housing). The arrangement in the area of the worm shaft has the additional advantage that it rotates faster than the toothed connection element due to the speed reduction of a worm drive. In a single-start worm, which represents the rule in mechanical engineering, the worm completes one rotation around its axis, whereas the toothed worm ring moves forward by only one tooth at the same time. In such a single-start worm, the speed reduction ratio is therefore ü=n_{A}/n_{S}=1/z, where nA stands for the speed of the toothed connection element, n_{S} stands for the speed of the worm, and z is the number of teeth of the toothed connection element. The speed nₛ of the worm is thus equal to the speed of the toothed connection element, multiplied by its number of teeth:

nₛ=n_{A}*z.

One therefore has to regard only one complete rotation of the worm shaft, in order to detect what is happening to one single tooth of the toothed connection element.

The tooth flank involved—i.e. the front one or back one in the direction of rotation—is derived less from an accurate analysis of the angle of rotation, and more or primarily from the direction of the transmitted torque, since each tooth flank can only transmit pressure forces. That is why it is advantageous to know the direction of torque. In a worm that is mounted with limited movement in axial direction and centred by means of spring forces, this information can especially be obtained by observing its axial displacement.

This is because the worm is exposed to an axial force in one or the other longitudinal direction during torque transmission, and therefore deviates from its zero point in that very direction due to its spring suspension. The associated tooth flank of the concerned tooth can thus be determined from the direction of this deflection and, at the same time, the force acting on the concerned tooth flank at that very moment can be determined from the amplitude of the deflection of the worm, so that the load on individual tooth flanks can be precisely documented in respect of their duration and magnitude, in order that damages to the toothing caused by overloads can be estimated; furthermore, the load can even be integrated in terms of time, so that the prospective wear of the toothing over time can be estimated. Additionally, the total rotational angle of the main bearing, covered independent of the direction of rotation, can be determined, from which a measure of the wear of the rolling bearing(s), i.e. of the rolling elements and of the raceways, can be determined. With all this information, a technician can detect—without dismantling the slew drive main bearing—whether the slew drive is in need of repair, in particular whether the next maintenance round needs to be advanced.

The invention can be further developed in a way that information about the overall angle of rotation and/or the (mean) speed of the worm or of the worm shaft can be obtained with the help of a measured value of their rotation. These pieces of information shed light on the dynamic loading of the slew drive, predominantly in respect of its (main-) bearing, in particular in respect of the current wear of the rolling elements and raceways.

Moreover, it is in accordance with the teaching of the invention, that information about the overall or mean torque load on the worm or the worm shaft can be obtained from their axial displacement. This information also sheds light on the dynamic loading of the slew drive, predominantly in respect of the toothing on its toothed connection element and/or in respect of the currently expected condition of the worm thread.

Finally, particularly interesting is a combined evaluation, wherein the applied torque is integrated depending upon the angle of rotation, in order to, so to speak, “keep a book” of each tooth of the toothed connection element and to detect local overloads. Such an evaluation is primarily advantageous in special application cases, when a worm drive executes only a few movements, but is simultaneously exposed to high static torque loads, such as blade bearings of wind energy plants or tracking of solar energy plants, etc.

In a further development in accordance with the invention, the use of the worm gear in accordance with the invention can be conceived as a replacement or retrofit unit. If the invention is used in such a sense, then the spare parts market in particular opens up additionally for the sale of the device in accordance with the invention.

This implies: The worm gear mechanism in accordance with the invention can, for instance, be used as a spare slew drive to replace conventionally used slew drives, i.e. conventional slew drives without an additional sensor system in accordance with the invention.

This case especially offers the option that the present invention can be, but does not necessarily have to be, provided with the sensor system in accordance with the invention. Alone through the provision of fastening options for the aforementioned sensor system in or on the housing of the worm gear in accordance with the invention, the purchaser or the customer is offered the option of simply having the sensor system in accordance with the invention retrofitted “at a later date”.

In that case, though the present invention is provided with the respective bores for attachment of the aforementioned sensor system, these bores are covered again with removable dummy sockets or housing covers before leaving the assembly line or the factory. Such dummy sockets or covers can advantageously be made of plastic or metal, or be made up of multiple individual parts as necessary. If necessary, these dummy sockets or covers can even be sealed against the penetration of moisture, as separate from the housing of the worm gear in accordance with the invention.

In the framework of a very special and especially cost-effective further development of the invention, slide bearing elements too can be used for the bearing of the worm shaft instead of the aforementioned rolling bearing. Though this has disadvantages in respect of friction—as sliding friction involves higher wear than rolling friction—interesting and more economical embodiments can be developed through the use of modem material pairings between the supporting element and the supported element, in particular in view of the fact that rolling elements can be dispensed with.

Such a further development of the invention is especially advantageous in those worm gears in accordance with the invention which do not rotate permanently. The slide bearing material in that case can be composed of a metallic as well as a non-metallic base material, also with (composite) material pairings in accordance with the invention, as long as positive sliding friction characteristics predominate.

In another, equally specific embodiment of the invention, it is conceivable and technically possible to fasten multiple sensors onto or in the housing of the worm gear in accordance with the invention—this fastening can also be detachable if required—, so that such a sensor can be exchanged.

A further technical teaching of the invention has proved to be advantageous, according to which such a(n) (exchangeable) sensor, whose parameter- or measured value acquisition takes place not axial, but radial to the worm shaft, and thereby perpendicular to the ascending slope of the worm, is mounted or can be mounted in a way that it can capture the rotation of the worm shaft with the help of the virtually constantly changing position of a scanned thread area at the site of the sensor and can map it as a periodical, in particular approximately sinusoidal signal. If a contactless sensor or transducer is used in this case, then this sensor built into, preferably screwed onto the housing “sees” that the distance between the point fixed by the sensor on the worm shaft and the sensor is approximately sinusoidal. As this sinus form recurs constantly, the desired distance between the point fixed on the worm shaft and the sensor can always be pre-calculated using an electronic system or evaluation unit connected to or connectible to the sensor.

If the actual distance between the sensor and the point fixed by the sensor on the worm shaft is different from that desired distance, this at least indicates a possible malfunction or wear of the mechanical component. This possible malfunction or wear can be electronically classified and evaluated.

Further characteristics, details, advantages on the basis of the invention are revealed in the course of the following description of a preferred embodiment of the invention with the help of the drawing. Here:

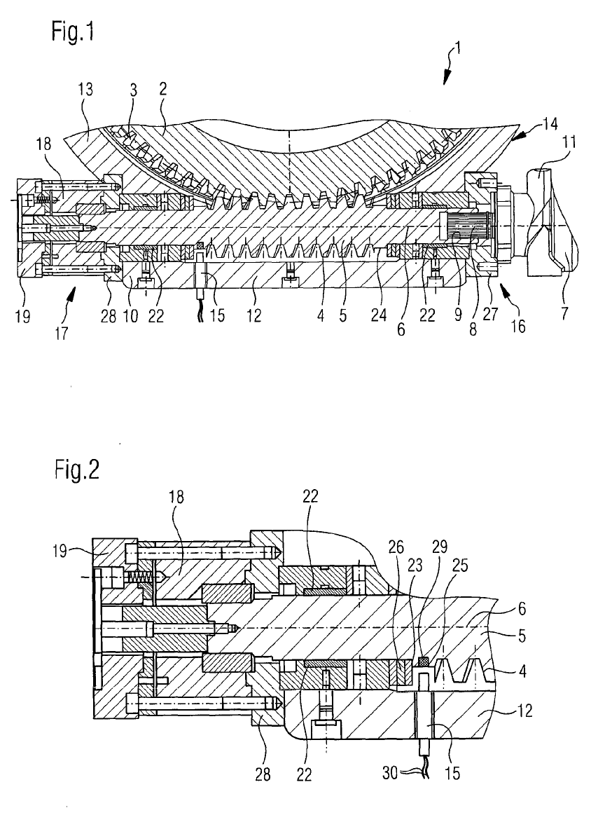

FIG. 1 illustrates a step through a worm gear in accordance with the invention in parallel to the primary level of the worm wheel, partially aborted;

FIG. 2 shows a detail from FIG. 1 in an enlarged version;

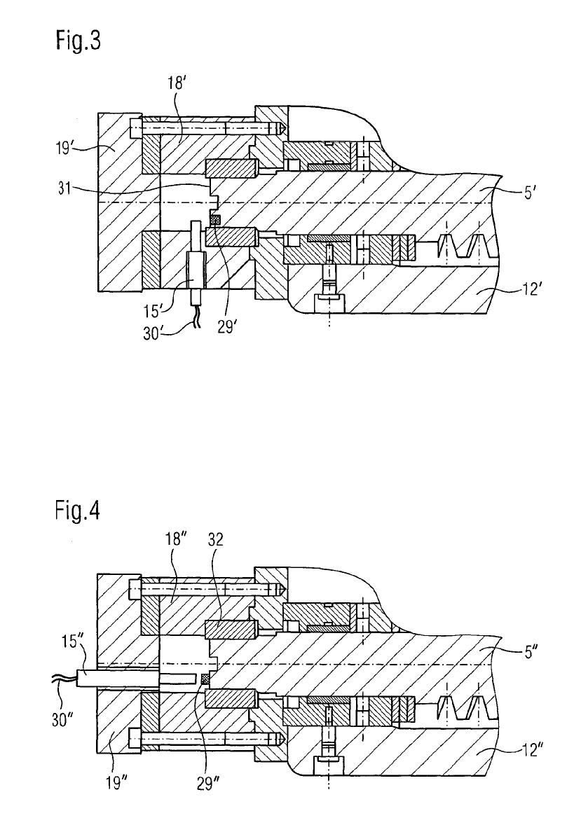

FIG. 3 shows a modified embodiment of the invention in an illustration in accordance with FIG. 2;

FIG. 4 shows another modified embodiment of the invention in an illustration in accordance with FIG. 2;

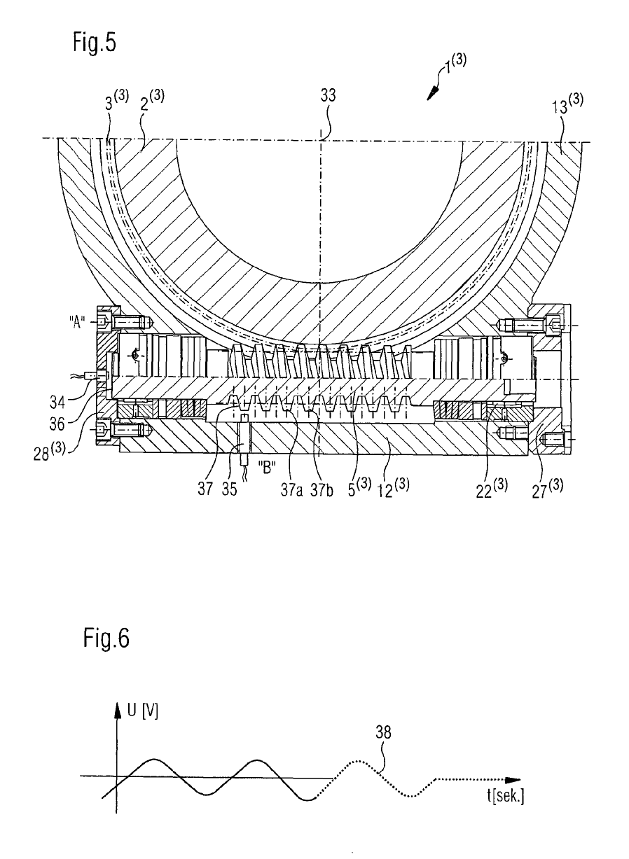

FIG. 5 shows yet another modified embodiment of the invention in a sectional drawing approximately corresponding to FIG. 1, wherein the possible attachment or fastening sites “A” and “B” for the sensor system in accordance with the invention are plotted; in the context of an aforementioned “retrofit” application, these attachment or fastening sites can be provided with dummy sockets or covers; and

FIG. 6 shows an exemplary oscillogram of the output signal of a sensor mounted at site “B” in FIG. 5.

The arrangement reproduced in FIGS. 1 and 2 shows an aborted step along the primary level of a slew drive 1 in accordance with the invention. The slew drive 1 serves to connect two different machine or installation modules with each other in a way that they can be rotated around exactly one axis, but are otherwise non-displaceable.

Each of these two different machine or installation modules is connected to one annular connection element each of the slew drive 1, in particular via screw connection, out of which one connection element 2 can be seen in FIG. 1, which is provided with a toothing 3 on its outer circumference. The thread 4 of a worm 5 meshes with the toothing 3, with a longitudinal axis 6 running approximately tangential to the toothing 3 at the meshing point of the toothing, which otherwise runs in or parallel to the primary plane of the slew drive 1. This worm 5 is in turn driven by a drive motor 7, whose output shaft 8 is connectible to the worm 5 for rotation therewith, in particular through insertion in a recess 9 on the face of the worm 5.

The function of a counter-bearing for the drive motor 7 is served by a part 10 of the slew drive 1 bearing the worm 5, to which the housing 11 of the motor 7 is fastened, in particular flange-mounted. Preferably, the part 10 encompasses the worm 5 as housing 12 over its entire length, in order to protect its thread 4 against contamination from dust and other particles.

The slew drive 1 demonstrates a second, annular connection element, which is rotatable relative to the first, annular connection element 2. As the arrangement is open-centre, both the connection elements 2 are supported against each other via at least one circumferential row of rolling elements. This bearing is designed in such a way that it can absorb overturning torques and axial forces between both the connection elements 2, so that the worm 5 meshing with the toothed connection element 2 only perceives the torque of this connection element 2, whereas overturning torques and/or axial forces occurring between both the connection elements 2 are kept away from the worm 5.

For the arrangement of the second, untoothed connection element, there are at least two different methods of construction:

In a first embodiment, the second, untoothed connection element lies radially outside the first, toothed connection element 2. In such a case, the bearing(s), i.e. the raceways, must be displaced in axial direction, i.e. upwards and/or downwards, relative to the toothing 3 in the direction of the rotational axis of the main bearing of the slew drive 1. In this case, the second, untoothed connection element can be designed as part 13 of the slew drive housing 14, namely as an annular housing part 13, which encompasses the toothed connection element 2 on the outside. The housing parts 10, 12, 13 are connected to form one single, rigid housing 14 or are preferably integrated in one piece.

In a second embodiment now shown here, the second untoothed connection element lies radially inside the first, toothed connection element 2. In such a case, the bearing(s), i.e. the raceways, can be arranged at the height of the toothing 3, i.e. in upward direction and/or downward direction. In this case, however, the second, untoothed connection element does not constitute a direct component of the slew drive housing 14, but is connected with its annular housing part 13, which encompasses the toothed connection element 2 on its outside, by means of an annular plate running alongside and at a distance from one front face of the toothed connection element 2. In this case as well, the housing parts 10, 12, 13 are connected to form one single, rigid housing 14 or are preferably integrated in one piece.

The housing part 10, 12 encompassing the worm 5 demonstrates a cylindrical shape, rotation-symmetrical relative to the longitudinal axis 6 of the worm 5, except for the contact surface with the housing part 13 encompassing the connection element 2, where the housing part 12 gives up its cylindrical shape in favour of the housing part 12.

Such type of partially cylindrical housing part 12 for the worm 5 demonstrates two front-face ends 16, 17, with the motor 7 flange mounted onto the end 16. The opposite end 17 can be prepared for connection to a brake or a tachometer or the like. For this purpose, an adapter 18 can be provided at that place, with a distance piece screwed onto the worm 5 and with a defined opening in the centre for accepting a rotary connection of a brake or a tachometer.

The said adapter 18 can demonstrate an annular connecting flange 19 covered by a thin, detachable cover plate.

The thread 4 encompasses the worm 5 only in its centre region, where it meshes with the toothing 3; the two end regions 20, 21 of the worm shaft 5 are smooth or rotation-symmetrical and serve, among other things, as bearing for the worm shaft 5 by means of rolling bearings 22. Between its thread region 4 and the bearing regions at both ends 22, the worm shaft can additionally demonstrate at least one graduation 23 each in a way that the peripherally adjacent shaft regions 20, 21 demonstrate a smaller diameter than the shaft areas 24, 25 lying proximal to the graduation 23. These graduations 23 are supported in the direction of the longitudinal axis 6 by means of disc springs 26 or laminated disc springs 26 at one blind flange 27, 28 each of the housing part 12, so that the worm shaft 5 is displaceable to a limited extent relative to its surrounding housing part 12 in the direction of its longitudinal axis 6, but is centred in a zero position by both the disc springs 26 or the laminated disc springs 26 when it is in a condition that is free of external influences.

In the embodiment according to FIGS. 1 and 2, the worm shaft 5 demonstrates an inhomogeneity inconsistent with the rotation symmetry in a shaft region 24, 25 between the thread section 4 and an adjacent graduation 23, preferably in the region of the shaft end 20 facing away from the motor 7. This can be arranged in the shaft body 5, e.g., by means of a circumferential recess or a radial blind bore. This can especially be a reference element 29 in the form of a small magnet. This element can either demonstrate only a short extent, in particular if is accommodated in a bore, or can stretch across the circumference at a greater angle, preferably at an angle of 180°, if it is accommodated in a circumferential recess.

At least one sensor 15 cooperates with this reference element 29, preferably a magnetic sensor such as a hall-effect sensor or the like, and then transmits a signal to its output ports 30 each time when the reference element 29 is in its proximity. Preferably, there are two sensors 15 displaced by 90° relative to each other, both of which can be oriented to the same recess. Due to their phase offset, one can not only determine the exact position of the worm shaft 5 to an accuracy of 180° with this arrangement, but also the respective direction of rotation. The longitudinal stretch of the reference element 29 should at least correspond to approximately the length of the entire displacement range of the shaft 5 in axial direction, so that the measurement result is not adversely affected by an axial displacement of the shaft 5.

With this arrangement, the rotational position and direction of the worm shaft 5 can thus be determined independent of the transmitted torque.

The worm shaft 5 can additionally demonstrate one more recess, i.e. a circumferential notch, for example with a rectangular or trapezoidal cross-section tapering off to the base of the notch, for the purpose of scanning carried out by other sensors. This notch need not necessarily demonstrate a magnetic element, but can itself serve as a reference element. Naturally, however, it could also have circumferentially arranged magnetic elements. However, this second reference element encompasses the worm shaft 5 completely and as homogeneously as possible. Preferably two further sensors cooperate with such a reference element, which are, however, arranged in such a way that each of them is located over one lateral edge each of the notch. If the worm shaft 5 is now displaced under the influence of a torque meant to be transmitted to the toothed connection element 2, then the notch still lying symmetrically between the two sensors in the central zero position of the worm shaft 5 approaches one of the two sensors and at the same time moves away from the other. Consequently, one sensor will sense and transmit approaching movement and the other distancing movement. Due to the degree of this displacement, the axial displacement of the worm shaft 5 and the axial force to be generated thereby, i.e. the torque transmitted to the toothed connection element 2, can be determined

In order not to influence each other, the sensors 15 and reference element 29 for the rotational position and direction can be arranged, e.g., in the region 24 of the worm shaft 5; the sensors and reference element for the torque can be arranged in the region 25 on the other side of the thread 4.

Naturally, other positions for the sensors 15 and reference element 29 for the rotational angle and direction as well as for the torque are conceivable as well. Thus, for instance, FIGS. 3 and 4 illustrate that the reference element 29 can be arranged in the region of one front face 31 of the worm shaft 5 as well, in particular on the front face 31 facing away from the motor 7. The reference element can be admitted in the front face 31 as can be seen in FIG. 3 or can be surface-mounted, as shown in FIG. 4. The said sensor 15′, 15″ can then either be arranged in an outer shell of an adapter 18′ present there, extending across it up to the cavity leading to the shaft 5′, as can be seen in FIG. 3, or the sensor 15″ can be fastened onto a connecting flange 19″ that closes off its front face, as shown in FIG. 4. Even in these cases, multiple reference elements and/or reference notches can be arranged radially within each other, with accordingly oriented sensors.

Further places for positioning the reference elements 29 and sensors 15 for the rotational angle, direction and/or torque acquisition are conceivable, for example between bearing points 22 and the seals 32 sealing off the cavity between the worm shaft 5 on the one hand and the housing 10, 12 on the other hand

With the help of the sensor output signals, information about the condition of the slew drive 1 can be collected and read out as required. Saving and pre-processing of output signals of the sensors 15, 15′, 15″ is performed by an electronic component or an electronic circuit, which is preferably integrated with the worm drive 1 or can be fastened onto it, for example in a box screwed onto the housing 14.

The mechanical components of the worm gear 1⁽³⁾ according to FIG. 5 do not differ significantly from those of the worm gear 1 shown in FIG. 1. Likewise present, although not explicitly shown, is the toothing 3⁽³⁾ of the annular connection element 2⁽³⁾ . Likewise not shown are the fastening bores in the toothed connection element 2⁽³⁾ , which bores extend across said connection element at least partially, arranged so as to be distributed in a ring, and end in a planar connection surface. Preferably, these fastening bores, arranged so as to be distributed in a ring, as well as the toothing 3⁽³⁾ have been created by forming or working them into one single, common, annular main body for the connection element 2⁽³⁾ .

This worm gear 1⁽³⁾ too has a second, likewise annular, connection element, which is coupled to the connection element 2⁽³⁾ in a free-moving, rotatable fashion via a bearing, preferably a rolling bearing, around a central axis 33 at the centre point of the annular connection elements 2⁽³⁾ .

Likewise present is an annular housing part 13⁽³⁾ encompassing the toothed connection element 2⁽³⁾ on the outside and a cylindrical housing part 12⁽³⁾ connected to said annular housing part and running approximately tangential to it.

The latter houses a worm 5⁽³⁾ , whose thread 4⁽³⁾ meshes with the toothing 3⁽³⁾ of the connection element 2⁽³⁾ .

The thread region 4⁽³⁾ as well as the radially extended regions 24⁽³⁾ adjoining it in axial direction at both ends are supported, via laminated disc springs 26⁽³⁾ and sleeve-like elements, in displaceable fashion against restoring spring forces in both axial directions by blind flanges 27⁽³⁾ , 28⁽³⁾ connected to, in particular screwed onto, the cylindrical housing part 12⁽³⁾ . The blind flange 27⁽³⁾ is annular in shape, so that it can be accessed from the output shaft of a motor.

The worm 5⁽³⁾ is additionally supported radially in the sleeve-like elements by means of worm bearings 22⁽³⁾ , in particular in the form of needle or rolling bearings.

Different from the worm gear according to FIG. 1, the worm gear 1⁽³⁾ according to FIG. 5 simultaneously has two sensors 34, 35.

Their mounting sites are marked as “A” for the sensor 34 and “B” for the sensor 35 in FIG. 5. The mounting site “A” is located in the blind flange 28⁽³⁾ opposite one of the drive motors; the mounting site “B” is located in the cylindrical housing region 12⁽³⁾ at the height of the thread region 4⁽³⁾ of the worm 5⁽³⁾ .

In the illustrated embodiment, both the sensors 34, 35 are proximity sensors, in particular inductive proximity sensors. An inductive proximity sensor encompasses, e.g., an electrical coil, preferably with a ferrite core; an oscillator excites the coil with an alternating voltage; the resultant magnetic field is bundled by the ferrite core and is directed to the sensitive region of the room in front of the head of the sensor 34, 35. The electric coil is simultaneously the source of the magnetic field as well as the actual sensitive element. This is because, in an approaching metallic element, eddy currents can be generated, which extract energy from the magnetic field and thereby from the oscillating circuit, so that the oscillating circuit is damped and the oscillator voltage sinks; furthermore, the inductance L of the oscillator can be influenced by the metallic element penetrating the magnetic field and thereby the vibration frequency can be changed. Both the effects can be detected and evaluated either individually or jointly, to arrive at a measure of the distance and/or the size of the approaching object. If—as in this case—the size and nature of the object is known, the respective distance can be determined on that basis, i.e. not only is a rough evaluation with one single switching threshold possible, as in an inductive proximity switch, which only switches on and off, but also the sensor output signal can be evaluated in detail with respect to its amplitude in order to generate a signal that is characteristic for the distance or is even proportional to this distance. Since the lubricant present within the worm housing 12⁽³⁾ , in particular lubricating grease, is non-metallic and therefore neither damps the oscillating circuit nor influences its vibration frequency, the presence or absence of lubricating grease or the like does not falsify this measurement.

The sensitive region of the sensor 34 in the blind flange 27⁽³⁾ is directed towards the front face 36 of the worm shaft 5⁽³⁾ located there (or a metallic part connected to it for rotation therewith); as the worm shaft 5⁽³⁾ is metallic, it is captured by the sensor 34, i.e. an axial displacement of the worm shaft 5⁽³⁾ influences the output signal of the sensor 34.

The worm shaft 5⁽³⁾ is in a central position which is free of external influences, and from which it can be deflected in both axial directions. Accordingly, the sensor 34 should be mounted in a way that it can not only capture an approximation of the worm shaft 5⁽³⁾ , but also a movement away from it. Then—given a roughly linear relationship between the sensor output signal and the distance from the worm shaft 5⁽³⁾ by multiplication with a conversion factor; in the case of non-linearities, e.g., with the help of a table—the current axial position of the worm shaft 5⁽³⁾ can be determined from the output signal of the sensor 34, and/or spring force proportional to it in accordance with the spring rates of the laminated disc springs 26⁽³⁾ , and/or the torque proportional to the latter, with which the worm 5⁽³⁾ acts on the connection element 2⁽³⁾ via the meshing of the thread 4⁽³⁾ with the toothing 3⁽³⁾ . However, this torque is a first important measured value for determining the wear within the worm gear 1⁽³⁾ .

A no less significant influence on the wear within the worm gear 1⁽³⁾ is exerted by the rotational speed of the connection element 2⁽³⁾ relative to the annular housing part 13⁽³⁾ or the rotational speed of the worm shaft 5⁽³⁾ proportional thereto and relative to the worm housing 12⁽³⁾ . This speed is therefore also a relevant measured value and is captured with the help of the second sensor 35.

The sensitive region of the sensor 35 is directed towards the thread region 4⁽³⁾ of the worm shaft 5⁽³⁾ and senses the thread ridge there. If one regards the thread 4⁽³⁾ , then the thread winding located nearest to the sensor 35, i.e. the individual thread ridge 37 as cross-section of one individual winding of the thread 4⁽³⁾ with the drawing plane, wanders continuously in one axial direction along the axis 6⁽³⁾ of the worm shaft 5⁽³⁾ during one rotation of the worm shaft 5⁽³⁾ . In the case of the right-hand thread 4⁽³⁾ shown in FIG. 5, the thread section 37 nearest to the sensor 35 wanders in axial direction towards the blind flange 27⁽³⁾ , seen from the motor or from said annular blind flange 27⁽³⁾ , with one rotation of the worm shaft 5⁽³⁾ in clock-wise direction; when rotating in anti-clockwise direction, it moves away from said blind flange.

When the worm shaft 5⁽³⁾ is rotating continuously in one direction, this thread section 37 moves farther and farther away from the sensor 35 and is outside its range at some point of time; at the same time, however, an adjacent “virtual” thread ridge 37a , as cross-section of one individual winding of the thread 4⁽³⁾ with the drawing plane, wanders from the opposite axial direction towards the sensor 35 and can be captured by it; after each complete rotation of the worm shaft 5⁽³⁾ , the thread ridge 37a that has passed by is followed by one more, adjacent, virtual thread ridge 37b , 37c , etc. During one continuous rotation of the worm shaft 5⁽³⁾ , therefore, one thread ridge always moves closer and closer to the sensor 35 and then moves away from it again; the sensor therefore delivers an approximate mapping of the thread cross-section as output signal; an oscillogram of such a signal 38 is reproduced in FIG. 6. It can be seen there that this happens periodically, with the period T being inversely proportional to the number of rotations n of the worm shaft 5⁽³⁾ :

T=1/n,

where n is measured in U/min (revolutions/minute).

At 15 U/min, T=60 sec/15 U=4 sec.

This means that a constant speed nₛ of the worm shaft 5⁽³⁾ could, for instance, be determined by determining the period T of the output signal 38 of the sensor 35.

If one knows the curve shape of the signal 38 or the function of the amplitude of the output signal during continuous rotation of the worm shaft 5⁽³⁾—which is periodical and therefore needs to be recorded only during one single rotation of the worm shaft 5⁽³⁾—then an even more precise evaluation is possible, namely with the help of the inverse function of this very curve shape.

This shall be explained with the help of an assumption that the signal 38 is sinusoidal during continuous rotation of the worm shaft 5⁽³⁾ :

U=U₀*sin(2πt/T).

Then it follows for the angle of rotation φ, that:

φ(t)=2=πt/T=arcsin (U/U₀)

Thus, the inverse function arcsin can be used to determine the current angle of rotation (φ) of the worm shaft 5⁽³⁾ , or its time derivative dφ)/dt can be used to determine the speed nₛ of the worm shaft 5⁽³⁾ , and naturally also the speed n_{A} of the connection element 2⁽³⁾ can be determined via the transmission ratio ü=n_{A}/nₛ=1/z.

Furthermore, by continuously monitoring the angle φ and using the transmission ratio ü, one could also determine the current angle of rotation (Φ) of the connection element 2⁽³⁾ , in order to detect, e.g. as to which teeth of the toothing 3⁽³⁾ are meshed with the thread 4⁽³⁾ at just that point of time. Then, with the help of an overload in accordance with the torque, which is indicated by the sensor 34, one could, e.g., detect as to which tooth of the toothing 3⁽³⁾ could have possibly suffered damage.

For that, however, it would be necessary, in particular in reversible drives, that the speed nₛ=n_{A}/ü is always calculated with proper plus or minus prefix. On the other hand, the direction of rotation of the worm shaft 5⁽³⁾ is not detectable from the signal 38, in particular then when one reversal of direction of rotation takes place at an angle of rotation φ, where the signal 38 is currently located at or in the range of an extreme value of the periodical function, i.e. at U=±U₀.

In order that the direction of rotation can be reliably determined even at these two positions, one would have to use one more sensor, which is mounted in the worm housing 12⁽³⁾ like the sensor 35 and scans the thread 4⁽³⁾ , but is mounted with an offset relative to the sensor 35 in such a way that it delivers a periodical output signal displaced by approximately 90° relative to the signal 38, i.e., e.g, a cosine signal, when the sensor 35 delivers a sinusoidal signal. Such an offset mounting can be implemented in several ways:

On the one hand, the additional sensor could be arranged in the same plane as the sensor 35—through which plane the axis 6⁽³⁾ extends perpendicularly—but with an approximate displacement by a rotation angle Δφ=90° relative to the sensor 35. This could, e.g., be implemented in a way that a sensor 35 in FIG. 5 is arranged with an upward displacement by an angle φ=+45° relative to the primary plane of the worm gear, i.e. the drawing plane, whereas the other sensor is displaced downward by an angle φ=−45° relative to this primary level.

On the other hand, the additional sensor could even be arranged in the same longitudinal plane along the axis 6⁽³⁾ as the sensor 35, but displaced, in particular displaced by a path ΔI, in the direction of the longitudinal axis 6⁽³⁾ of the worm shaft 5⁽³⁾ , where:

ΔI=[¼±k*½)]*P,

where P is the rise of the worm thread 4⁽³⁾ and k a natural number.

Combinations of Δφ* a and ΔI mod P* b+P*m are also possible, i.e. a displacement in the direction of rotation by Δφ* a and simultaneously a displacement in longitudinal direction by ΔI mod P*b+P*m. The function ΔI mod P always delivers one of the above values for k=0 or k=1, i.e. ¼*P or ¾*P. Depending upon whether the worm thread 4⁽³⁾ is right-handed or left-handed thread, one value out of these two is to be selected, where the following shall also apply: a+b=1. If, e.g., a=1, then a displacement in the direction of rotation by 90° follows and if b=0, then a displacement in longitudinal direction by P*m follows, where m is a natural number.

The specified values for Δφ and ΔI need not be adhered to exactly; however, both the sensors 35 should be arranged in a way that the periodical sensor output signals 38 have a mutual phase offset of approximately ±90°. Then, each time a signal approaches an extreme value U=±U₀, a switch-over to the other sensor can take place, the output signal of which other sensor is then situated in the range of the zero crossing at that point of time, and has a maximum rise there so that a reversal of direction of rotation can immediately be detected.

This applies in any case as long as the worm shaft 5⁽³⁾ experiences only a slight axial displacement or none at all, since the periodicity in the signal 38 of the sensor(s) 35 is then caused “only” by the direction of rotation φ.

As already described above, the worm shaft 5⁽³⁾ is also capable of axial deflections ±x in both directions at greater torques thanks to its axial spring suspension. This could trigger measurement errors in the speed or in the angle of rotation, in particular if the axial deflection lxl in absolute terms is in the magnitude of the thread ridge P or higher. This depends on the maximum permissible spring travel Xₘₐₓ of the disc springs 26⁽³⁾ in ratio of the thread ridge P.

As help, one could therefore distinguish between the cases xₘₐₓ<<P and P≈xₘₐₓ or greater:

If xₘₐₓ<<P can be implemented in the design, then possible axial deflections lxl<xₘₐₓ<<P should not lead to any permanent measured value falsifications, so that a counter-measure is not necessary.

If this cannot be ensured in the design, a mathematical compensation could be introduced, in which the currently measured axial displacement x is converted into an equivalent compensatory rotational angle φcomp with the help of the thread ridge P, e.g. using the formula:

x/P=φcomp/360°

or:

φcomp=360°*x/P

This compensatory rotational angle φcomp would have to be subsequently converted into a real or actual total value φtotal by addition to or subtraction from the measured angle of rotation φmeas depending upon whether the worm thread 4⁽³⁾ is right-handed or left-handed thread:

φtotal=φmeas±φcomp

On the basis of that, the time derivative can then be used to always calculate the real speed, and also always the actually meshed tooth of the connection element 2⁽³⁾ , etc.

Thus, for each of the z teeth of the toothing 3⁽³⁾ , a memory chip could “keep a record” of the (average) load with which a particular tooth participated in the overall “work” of the worm gear 1⁽³⁾ , or the proportion in which the (previous) total load on the worm gear 1⁽³⁾ was distributed over the individual teeth.

### LIST OF REFERENCE NUMERALS

1 slew drive
2 connection element
3 meshing system
4 thread
5 worm
6 longitudinal axis
7 drive motor
8 output shaft
9 recess
10 part
11 motor housing
12 housing part
13 housing part
14 housing
15 sensor
16 end
17 end
18 adapter
19 connecting flange
20 end region
21 end region
22 rolling bearing or slide bearing
23 graduation
24 shaft region
25 shaft region
26 disc spring
27 blind flange
28 blind flange
29 reference element
30 output port
31 front face
32 seal
33 principal axis
34 sensor
35 sensor
36 front face
37 thread ridge
38 signal

1. Worm gear (1), comprising a worm shaft (5) with a worm thread (4) formed or worked, in particular cut, directly into the shaft main body, and also comprising a worm wheel that meshes with said worm thread, which worm wheel is of annular form and is integrated with one of two mutually concentric annular connection elements (2), and these connection elements (2) are supported against each other in rotatable fashion and serve for connection to two machine or installation parts that are rotatable relative to one another, and having a housing (14) encompassing the worm wheel toothing (3) and the worm thread (4), wherein the toothed worm wheel connection element (2) is formed from an annular main body with a toothing (3) formed or worked directly into its outer circumference, characterized in that the
a) annular main body of the toothed worm wheel connection element (2) demonstrates at least one planar connection surface formed or worked directly into the main body, for abutment against a planar contact surface of the respective machine or installation part, and also having multiple fastening bores arranged so as to be distributed in a ring around the clear opening and formed or worked directly into the main body; the longitudinal axes of these bores extend perpendicularly through the respective connection surface;
b) and wherein the untoothed connection element is formed from an annular main body with at least one planar connection surface formed or worked directly into the main body of the untoothed connection element, for abutment against a planar contact surface of the respective machine or installation part, and also having multiple fastening bores arranged so as to be distributed in a ring around the clear opening, and formed or worked directly into the main body of the untoothed connection element; the longitudinal axes of these bores extend perpendicularly through the respective connection surface;
c) wherein at least one sensor (15) is provided in the housing (14), in particular in or on the housing (12) of the worm (5), for permanent acquisition of the rotary and/or displacement position of the worm or worm shaft (5).

2. Worm gear (1) according to claim 1, characterized in that the sensor (15) functions with contactless technology, in particular through magnetic or optical scanning of at least one superficial structure or superficial range of the worm or at least of a reference element fixed on the worm.

3. Worm gear (1) according to claim 2, characterized in that the sensor (15) captures the distance from the nearest superficial range of the worm (5).

4. Worm gear (1) according to claim 3, characterized in that the sensor (15) is designed as an inductive sensor.

5. Worm gear (1) according to claim 3, characterized in that the sensor (15) is oriented approximately radial to the longitudinal axis (6) of the worm shaft (5) and is directed towards the thread region (4) of the worm shaft (5).

6. Worm gear (1) according to claim one of the claims 3 to 5, characterized in that the sensor (15) is oriented approximately axial or parallel to the longitudinal axis (6) of the worm shaft (5) and is directed towards the front face region (4) of the worm shaft (5).

7. Worm gear (1) according to claim 1, characterized in that one sensor (15) is designed as a magnetic sensor, in particular as a hall-effect element.

8. Worm gear (1) according to claim 7, characterized in that a reference element (29) encompasses at least one magnet fixed on the worm or the worm shaft (5).

9. Worm gear (1) according to claim 1, characterized in that one sensor (15) is designed as an optical sensor, in particular by means of an element sensitive to light or infra-red radiation such as a photodiode.

10. Worm gear (1) according to claim 9, characterized in that a reference element (29) encompasses at least one element fixed on the worm or the worm shaft (5) with at least one pronounced coefficient of reflection.

11. Worm gear (1) according to claim 10, characterized in that the reference element (29) encompasses multiple incremental markings spaced apart from each other and having one pronounced coefficient of reflection.

12. Worm gear (1) according to claim 1, characterized by an evaluation unit for deriving wear-relevant data in respect of rotary and/or displacement position of the worm or worm shaft (5) based on the captured data, and then saving these data, where preferably the absolute value of the captured rotary or displacement path is formed and integrated.

13. Worm gear (1) according to claim 12, characterized in that the evaluation unit determines the direction of rotation of the worm or the worm shaft (5).

14. Worm gear (1) according to claim 13, characterized in that the evaluation unit determines and integrates the absolute angle of rotation covered depending upon the direction of rotation of the worm or the worm shaft (5).

15. Worm gear (1) according to claim 1, characterized in that the worm or worm shaft (5) is supported in an axially displaceable fashion.

16. Worm gear (1) according to claim 15, characterized in that the worm or worm shaft (5) is spring-mounted in axial direction, for example by means of at least one pressure spring, preferably by means of at least one disc spring (26), in particular by means of at least one laminated disc spring (26).

17. Worm gear (1) according to claim 12, characterized in that the evaluation unit determines an axial displacement of the worm or the worm shaft (5).

18. Worm gear (1) according to claim 17, characterized in that the evaluation unit determines the axial displacement direction of the worm or the worm shaft (5).

19. Worm gear (1) according to claim 17, characterized in that the evaluation unit determines and integrates the absolute (displacement) distance covered depending upon the axial displacement direction of the worm or the worm shaft (5).

20. Worm gear (1) according to claim 19, characterized in that the value to be integrated is weighted in a way that a rotational speed or torque related overload is weighted with a higher (proportionality) factor.

21. Worm gear (1) according to claim 12, characterized by a memory for measured values and/or measured values calculated by the evaluation unit and/or parameters integrated by the evaluation unit.

22. Worm gear (1) in accordance with claim 21, characterized in that space is provided in the memory for storing the type, duration and/or number of speed or torque related overloads, in particular for storing their respective maximum values.

23. Worm gear (1) according to claim 21, characterized by an interface for reading the measured, calculated and/or saved information.

24. Worm gear (1) according to claim 12, characterized in that the evaluation unit demonstrates at least one rechargeable battery.

25. Worm gear (1) according to claim 24, characterized in that the battery can be recharged via a power supply connection or via a photodiode or via an induction coil, in particular in the context of a transponder.

26. Method for the operation of a worm gear mechanism (1), comprising a worm shaft (5) with a worm thread (4) formed or worked, in particular cut, directly into the main body of the shaft, and also comprising a worm wheel (2) that meshes with said worm thread, which worm wheel is of annular form and is integrated with one of two annular, mutually concentric connection elements (2), which are supported against one another in rotatable fashion and serve for connection to two machine or installation parts that are rotatable relative to each other, characterized by the following steps:
a) the rotation and/or axial displacement of the worm or worm shaft (5) is measured continuously;
b) optionally, the measured value for the rotation and/or axial displacement of the worm or worm shaft (5) can be rectified, unless this has already been taken care of by the functioning of the sensor (15), and/or the subsequent evaluation can be assigned to different evaluation paths depending upon the angle of rotation and/or the direction of displacement and/or rotation, so that multiple parameter values can be entered;
c) the possibly rectified measured value(s) for the rotation and/or axial displacement is (are) integrated, and/or maximum values of the measured value(s) are determined;
d) the measured value(s), mean values(s), maximum value(s) or integral values(s) of the possibly rectified measured value(s) for the rotation and/or axial displacement is (are) saved.

27. Method according to claim 26, characterized in that a measured value for the rotation of the worm or worm shaft (5) can be used to derive information about the overall angle of rotation and/or the (mean) speed of the worm or the worm shaft.

28. Method according to claim 26, characterized in that information about the overall or mean torque load on the worm or the worm shaft (5) can be obtained from a measured value of their axial displacement.
